(19) United States
(12) Patent Application Publication
(10) Pub. No.: US 2016/0054216 A1
(43) Pub. Date: Feb. 25, 2016

(54) FIBER DELIVERY FOR LASER BOND INSPECTION

(71) Applicants: David W. Sokol, Dublin, OH (US); Jeff L Dulaney, Delaware, OH (US)

(72) Inventors: David W. Sokol, Dublin, OH (US); Jeff L Dulaney, Delaware, OH (US)

(21) Appl. No.: 14/835,506

(22) Filed: Aug. 25, 2015

Related U.S. Application Data
(60) Provisional application No. 62/041,647, filed on Aug. 25, 2014.

(51) Int. Cl. G01N 19/04; G02B 6/42; G02B 6/34; G02B 6/028; G02B 6/32

(52) U.S. Cl. CPC G01N 19/04; G02B 6/0288; G02B 6/32; G02B 6/34; G02B 6/4204

(57) ABSTRACT

Methods, systems, and apparatuses are disclosed for fiber delivery of a laser pulse used in laser bond inspection. In one embodiment, a system for fiber delivery of a laser pulse for laser bond inspection comprises a laser operable to produce the laser pulse, one or more optical fibers, and an inspection head.

This application claims priority from U.S. Provisional Patent Application No. 62/041,647, filed on Aug. 25, 2014, which is incorporated by reference herein in its entirety.

### BACKGROUND

Bonded materials are used in a variety of structural applications. For example, adhesively bonded, laminated composite structures are increasingly being used in aircraft construction to reduce weight, reduce or eliminate the number of separate components, and improve fuel efficiency. The presence of material defects in a composite aircraft structure can lead to disastrous failure of the structure under flight loads. These defects may exist in the composite laminate itself, as well as in the adhesive bonds in the structure. The defects may arise as a result of damage during service, or in the original manufacturing process.

The growing ubiquity of composite structures has led to an increased need for techniques to evaluate the strength of the composite structures, including the adhesive bonds themselves, without damaging or destroying the composite structures. Conventional nondestructive evaluation (“NDE”) techniques are useful when a gap, crack, or void is present in a bonded material. However, conventional NDE techniques do not adequately identify deficiencies, such as weak bonds or “kissing bonds,” where materials bonded together are in contact but without adequate structural strength. These deficiencies can result from bond surface contamination, improperly mixed or outdated adhesives, and improper adhesive application.

Laser bond inspection (“LBI”) is an NDE technique for testing the integrity of bonds in bonded materials and structures. LBI is a method that involves sending a precisely controlled dynamic stress wave through an adhesive bond of a composite structure. Generally speaking, and with reference to FIG. 1, LBI 100 may involve deposition of laser pulse 102 at a first surface 106 of a bonded material (also referred to herein as a “bonded article”) 104, which may generate a compressive stress wave 108. A first laser pulse 102 may be applied to first surface 106 of bonded article 104 with an opaque overlay 112 and a transparent (tamping) overlay 110 applied to surface 106. Laser pulse 102 may pass through transparent overlay 110 and may be absorbed by opaque overlay 112. A plasma may be created and as the plasma blows off, compressive stress wave 108 may be induced into surface 106. Generally speaking, no intentional heating may occur in the composite structure, and surface damage may be substantially or completely avoided.

A shape of stress wave 108 may be tailored to several hundreds of nanoseconds in duration. A magnitude of stress wave 108 may be a function of laser input irradiance, which may facilitate generation of calibrated stress waves. Compressive stress wave 108 may propagate through bonded article 104, and may pass through a bond of interest 114, to a second surface 116 of bonded article 104, where stress wave 108 may be reflected as a tensile wave (not shown). The tensile wave may propagate back through bonded material 104 and, when it reaches bond 114, the tensile wave may stress bond 114.

An application of dynamic stress on bonded article 104 may be selected to be low enough to have little or no effect on an integrity of bonded article 104 or bond 114 if bond 114 is sufficiently strong. However, if bond 114 is below a suitable strength, the tensile wave may cause bond 114 to fail or may expose a non-bonded nature of bond 114 (e.g. a kissing bond).

The present application is directed to novel systems and methods for fiber delivery of a laser beam used in LBI applications.

### SUMMARY

Systems and methods are provided for fiber delivery of a laser beam used in LBI applications.

In one embodiment, a system for fiber delivery of a laser pulse for laser bond inspection is provided, the system comprising: a laser operable to produce the laser pulse; an optical fiber, the optical fiber; and an inspection head.

In another embodiment, a system for fiber delivery of a laser beam used for laser bond inspection is provided, the system comprising: a laser, the laser configured to produce a laser pulse in an energy range from 1 J to 50 J with a temporal pulse width between 50 ns and 300 ns in a low-high-low pulse energy sequence to produce stress waves through a bond of a bonded article; an optical coupling system for coupling the laser pulse to an optical fiber, the optical coupling system comprising: a mirror operable to direct the laser pulse to another optical component; at least one of: a lens, a lenslet array, and a diffractive optic, the at least one of the lens, the lenslet array, and the diffractive optic, operable to focus the laser pulse into a core of at least one of: the optical fiber, and a tapered input section of the optical fiber; and a first optical connector operable to connect the laser system with the optical fiber; the optical fiber operatively connected to the laser system, wherein the optical fiber comprises a core, a cladding, and an outer coating; a cable to operate the inspection head, wherein the cable comprises at least one of: a power cable, a signal cable, and a hose; an inspection head, the inspection head operatively connected to the optical fiber and operable to output the laser pulse to the bonded article, the inspection head further comprising: a second optical connector operable to connect the inspection head with the optical fiber; an overlay output operable to generate at least one of: a transparent overlay and an opaque overlay; a laser output operable to output the laser pulse; a connection device operable to attach the inspection head to the bonded article; an evacuation device operable to remove effluent and backscatter produced during the LBI process; and a surface motion detector, wherein the surface motion detector is operable to detect and measure surface motion on the bonded article.

In another embodiment, a method for fiber optic delivery of a laser pulse to a bonded article under laser bond inspection is provided, the method comprising: generating a laser pulse with a laser; coupling and injecting the laser pulse into at least one of: an optical fiber, and a tapered input section of an optical fiber; transmitting the laser pulse through the optical fiber to an inspection head; and outputting the laser pulse from the inspection head to a surface of a bonded article.

### BRIEF DESCRIPTION OF THE DRAWINGS

The accompanying figures, which are incorporated in and constitute a part of the specification, illustrate various example systems, methods, and results, and are used merely to illustrate various example embodiments.

FIG. 1 illustrates a schematic of an initiation of a laser bond inspection process.

FIG. 2 illustrates an example schematic of a fiber optic laser beam delivery system.

FIG. 3 illustrates a schematic view of an example inspection.

FIG. 4 illustrates a schematic view of an example laser system.

FIG. 5 illustrates an example lenslet array.

FIG. 6 illustrates an example beam launch scheme and measurement system.

FIG. 7 illustrates a schematic view of an example step index fiber.

FIG. 8A illustrates an example taper of a fiber optic.

FIG. 8B illustrates an example fiber optic with tapered input/output.

FIG. 9 is a flow chart of an example method for delivering a laser beam pulse used in laser bond inspection via a fiber.

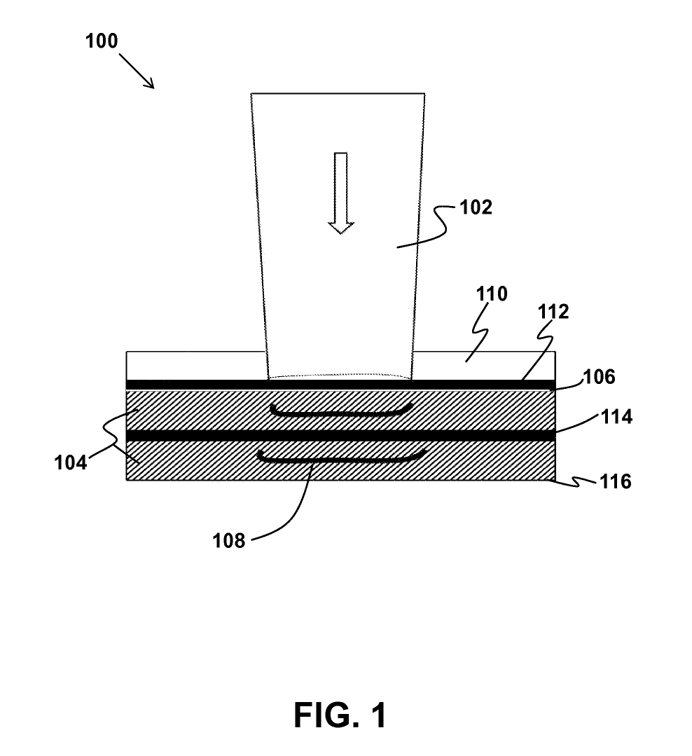

### DETAILED DESCRIPTION

Embodiments claimed herein disclose systems, methods and results of fiber delivery of a laser pulse used in LBI applications. As used herein, “fiber,” “fiber optic,” “optical fiber,” “optical cable,” and like variants may all be used interchangeably to describe a fiber used in fiber delivery of a laser beam used in LBI applications. “Delivery,” “transmission,” “propagation,” and like variants may be used to describe an act of transmitting all or part of a laser pulse via an optical fiber. “Coupling,” “injection,” and like variants may be used to describe an act of inputting all or part of a laser pulse into an optical fiber.

For many LBI applications, laser energies in a range of about 1 J to about 50 J with a temporal pulse width of about 50 ns to about 300 ns are suitable for the LBI process. For this energy and pulse width, it may be feasible to deliver laser pulses to an inspection head via single or multiple fibers instead of via an articulated arm or through the air. Fiber delivery of a laser pulse to a surface of a bonded article may be preferential to other delivery methods, because fiber delivery of a laser pulse: may provide better optical alignment stability; may provide increased flexibility in delivery of a laser pulse over long distances to a bonded article under inspection (e.g., at distances greater than about 50 feet); may require significantly fewer mirrors in delivering a laser pulse to a surface of a bonded article; and may provide more flexibility in delivering a laser pulse to locations that do not have a line of sight relative to the laser. Nevertheless, past endeavors of laser pulse delivery via an optical fiber may have been limited by limitations of the optical fiber.

Past testing of prototypes of fiber delivered laser systems may have provided methods to decrease a likelihood of fiber failure which may include: cleaving preparations of fiber faces to eliminate possible damage initiation by embedded polishing grit (which may also eliminate a need for CO₂ laser annealing); extending a bare fiber beyond a custom fiber connector to minimize effects of beam misalignment; using a multimode laser to provide a fairly uniform beam profile at a face of a fiber core; using a long focal length lens to produce a focal spot before beam entrance into a fiber; using a filtered, dry nitrogen purge gas to minimize gas breakdown at a beam focal point and limiting particulates from landing on a fiber face; and conditioning each fiber by gradually increasing beam fluence on a fiber face over a period of time. Past prototype testing may suggest maintaining a peak irradiance at or below about 1 GW/cm² in fibers to permit long-term, damage-free operation for LBI applications.

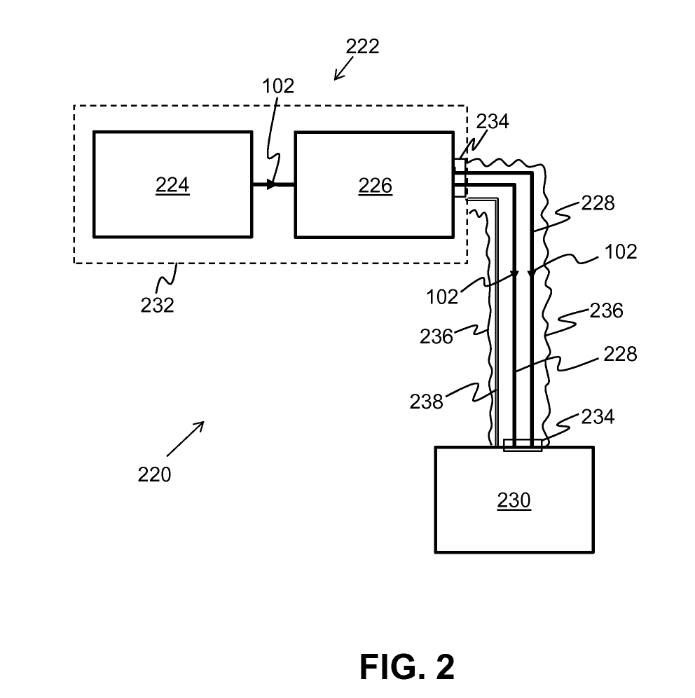

With reference to FIG. 2, an example schematic of an LBI system with fiber beam delivery 220 is illustrated. System 220 may comprise: a laser 224 to produce a laser pulse 102; an optical coupling system 226 to couple and inject laser pulse 102 into one or more optical fibers 228, and an inspection head 230 that may output laser pulse 102 for use in LBI applications. As used herein, “laser pulse” 102 may be refer collectively to: “a pulsed output,” “a pulsed laser beam,” “a laser beam pulse,” “a laser pulse,” “high pulsed laser energy,” “energy,” “a high power laser pulse,” “a pulsed laser output,” and like variants.

In one embodiment, laser 224 may include, for example, a neodymium:phosphate glass laser, such as, for example, those manufactured by LSP Technologies, Inc., a YAG laser, a YLF laser, or any other solid-state crystal material, in either a rod or a slab gain medium. Laser 224 may be configured to produce laser pulses 102 having: a pulse energy of between about 1 J and about 50 J (at the output of the final amplifier module); wavelengths between about 1053 nm and about 1064 nm, and a pulse width of between about 50 ns and 300 ns. As used herein, “laser” 224 may refer to a laser oscillator alone, or a laser oscillator in addition to optical amplification.

Laser 224 may be further configured to produce laser pulses 102 in a low-high-low or probe-break-probe pulse energy sequence (i.e., a first laser pulse 102 which may have a first energy, a second laser pulse 102 which may have a second energy that may be greater than the first energy but less than an energy required to break a properly constructed or “good” bond, and a third laser pulse 102 which may have an energy which is approximately the same as the first pulse's energy), as described and illustrated, for example, in U.S. Pat. Nos. 7,770,454 and 8,156,811. In this sequence, the low energy pulse 102 may interrogate a status of a bond 114 without significantly stressing bond 114, the high energy laser pulse 102 applied after the first low energy pulse 102 may apply a stress high enough to fail a weak bond 114 without damaging a strong bond 114, and the second low energy pulse 102 may further interrogate a status of a bond 114. Surface motion signals associated with a first low energy pulse 102 and a second low energy pulse 102 may be detected by a surface motion detector such an EMAT sensor, an acoustic sensor, an optical interferometer, and the like, and compared to determine weak or otherwise faulty bonds 114. In other words, a signal difference between a surface motion associated with a first low energy pulse 102 and a surface motion associated with a third low energy pulse 102 may be recorded and compared to evaluate a status of a bond 114 in a bonded article 104. Further configurations of laser 224 and inspection head 228 (also called a “processing head” or “process head”) may include, by way of example only, those described and illustrated in U.S. Pat. Nos. 7,770,454 and 8,156,811, and U.S. Pub. No. 2015/0122046, all assigned to LSP Technologies, Inc. and incorporated herein by reference.

In one embodiment, a laser system 222 may refer to a system comprising laser 224 and optical coupling system 226. Laser system 222 may provide all optical components necessary for producing laser pulse 102, modifying laser pulse 102, and coupling laser pulse 102 into fiber 228. Components of a laser system 222 may be arranged on any of an optical table and an optical rail, and components a laser system 222 may be contained within a chassis or housing 232.

Optical coupling system 226 may include such optical components necessary for further processing laser pulse 102, and coupling and injecting laser pulse 102 into fiber 228. Optical components comprising optical coupling system 226 may include, but are not limited to: one or more mirrors (not shown) to direct laser pulse 102; one or more beam splitters (not shown) to split laser pulse 102 from laser 224 into additional laser pulses 102; one or more lenses (not shown) to focus laser pulse 102 into fiber 228 and change a focus of laser pulse 102 within optical coupling system 226; one or more optical connectors 234 to operatively connect fiber 228 to at least one of: optical coupling system 226, laser system 222 as a whole, and inspection head 230; and one or more alignment lasers (not shown) to measure alignment of optical components in optical coupling system 226 to ensure that a proper alignment of optical components in optical coupling system 226 may be maintained. An optical connector 234 may comprise hardware to connect fiber 228, and maintain position of fiber 228 relative to at least one of: an optical table, an optical rail, a chassis 232, and inspection head 239. Specifically, an optical connector 234 may be used to maintain a position of at least one of: a face on a tapered I/O section, and face on fiber 228 relative to at least one of: an optical table, an optical rail, a chassis 232, and inspection head 230. Additional optical components in optical coupling system 226 may include amplifiers, relays, apodizers, beam shapers, pulse slicers, wave plates, beam expanders, polarizers, Faraday isolators, and like optical components (all not shown). In one embodiment, components of optical coupling system 226 may be used to modify an intensity profile of laser pulse 102 to flatten a laser pulse 102 to provide a flat top-shaped intensity profile, referred to herein as a “flat top-shaped beam,” or “flat top-shaped pulse.”

System 220 may comprise additional components such as umbilical assembly 236 to enshroud and protect one or more optical fibers 226 and one or more other cables 238. Umbilical assembly 236 may be of a highly flexible and protective material that may protect fiber 228 and other cables 238, while also allowing fiber 228 and other cables 238 to flex. Flexing of umbilical assembly 236 may allow fiber 228 and other cables 238 contained therein to flex, such that umbilical assembly 236 may be easily positioned and moved, so that inspection head 230 may be easily positioned and moved. As used herein, a “cable” 238 may refer to at least one of: a power cable, a signal cable, and a hose. A power cable 238 may be used to provide power to inspection head 230 and components within inspection head 230. A signal cable 238 may be used to transmit/receive electrical signals to and from inspection head 230 for purposes of sending control signals to and from inspection head 230, and transmitting data signals obtained from sensors on inspection head 230, for example, surface motion signals detected by a surface motion detector. A hose 238 may refer to one or more hoses, and may be used to convey a liquid, a gas, and a vacuum to and from inspection head 230.

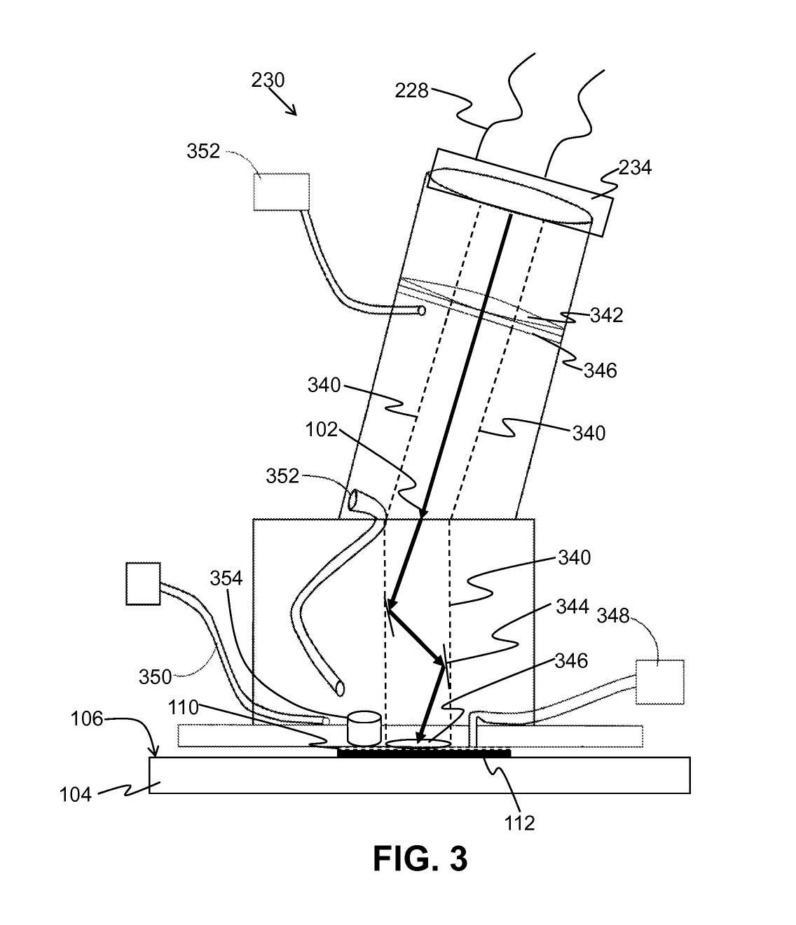

With reference to FIG. 3, a schematic view of an example inspection head 230 is illustrated. Inspection head 230 may operatively connect to fiber 228 and may be operable to output laser pulse 102 transmitted through fiber 228. In one embodiment, optical connector 234 may operatively connect fiber 228 to inspection head 230. Inspection head 228 may comprise a laser output 340 to output laser pulse 102. Laser output 340 may comprise at least one of: one or more lenses 342, one or more mirrors 344, one or more protective optics 346, and the like, that may cause laser pulse 102 to be output from inspection head 230 to a first surface 106 of bonded article 104. Inspection head 230 may comprise a connection device 348 operable to attach inspection head 230 to bonded article 104. In one embodiment, connection device 348 may be a vacuum attachment to provide a suction between inspection head 230 and bonded article 104 to maintain a position of inspection head 230 on bonded article 104. Inspection head 230 may comprise an overlay output 350 operable to generate at least one of: a transparent overlay 110, and an opaque overlay 112, used during LBI. Inspection head 230 may comprise an evacuation device 352 to remove effluent and backscatter (“debris”) produced during an LBI process. In one embodiment, evacuation device 352 may output a stream of compressed or pressurized air to clear debris from, for example, a protective optic 346 on laser output 340, and first surface 106 of bonded article 104. In another embodiment, evacuation device 352 may output a vacuum to remove debris from, for example, protective optic 346 on laser output 340, and first surface 106 of bonded article 104 by vacuum. Inspection head 230 may comprise a surface motion detector 354 operable to sense and measure surface motion on a surface of bonded article 104.

Multiple laser pulses 102 output from multiple optical fibers 228 to inspection head 230 may utilize a recombination technique to combine multiple laser pulses 102 as a combined output (not shown). Combining laser pulses 102 and outputting laser pulses 102 from inspection head 230, or directly from optical fibers 228, may provide a combined output as at least one of: a singular laser pulse (i.e. single spot), and a pattern of multiple laser pulses 102 (i.e. multiple spots). Multiple laser pulses 102 delivered via optical fibers 228 may be combined and output to provide a singular effect on a surface of bonded article 104—that is, a combined output of multiple laser pulses 102 may provide a similar effect as a single laser pulse 102 acting on a surface of bonded article 104, for example, a higher powered single laser pulse delivered by a mechanism other than an optical fiber 228. A combined output of multiple laser pulses 102 output at laser output 340 from inspection head 230 of LBI system with fiber beam delivery 220 may utilize, for example, 20 optical fibers 228 that may output 20 laser pulses 102. In this example, a variety of optics and connectors including, but not limited to: optical connector 234, lens 342, mirror 344, and protective optic 346 may be used to recombine the 20 laser pulses 102 to output a combined output at laser output 340. In keeping with this example, in one embodiment, a first laser recombination technique may direct each of the 20 laser pulses 102 from the 20 optical fibers 228 to a same output location (i.e. “stacking”) such that each of the 20 laser pulses 102 may overlap and be stacked on one another, where each of the 20 laser pulses 102 may comprise a same spot diameter (area) as another laser pulse 102. In this first technique, each of the 20 laser pulses 102 represent 1/20^{th} of a power and an energy density of the stacked output combination as a whole. In another embodiment using this example, a second laser recombination technique may output each of the 20 laser pulses 102 from the 20 optical fibers 228 as a pattern of spots that may cover an area under laser bond inspection. In one embodiment using the second recombination technique, a combined output of laser pulses 102 may be output in an overlapping spot pattern. In another embodiment using the second recombination technique, a combined output of laser pulses 102 may be output in a pattern that may not overlap (i.e. non-overlapping spot pattern). For the second recombination technique to maintain a same output power and energy density as described for the first laser recombination technique, the 20 laser pulse outputs 102 using the second laser recombination technique may be 1/20^{th} of a spot diameter (area) of the “stacked” spot diameter as used in a first recombination technique. LBI system with fiber beam delivery 220 may use any recombination techniques and any output pattern to provide a combined output. In one embodiment, a combined output of laser pulses 102 output from optical fibers 228 may be output from inspection head 230 to bonded article 104. In another embodiment, a combined output of laser pulses 102 from optical fibers 228 may be output directly from optical fibers 228 to a bonded article 104 without an inspection head.

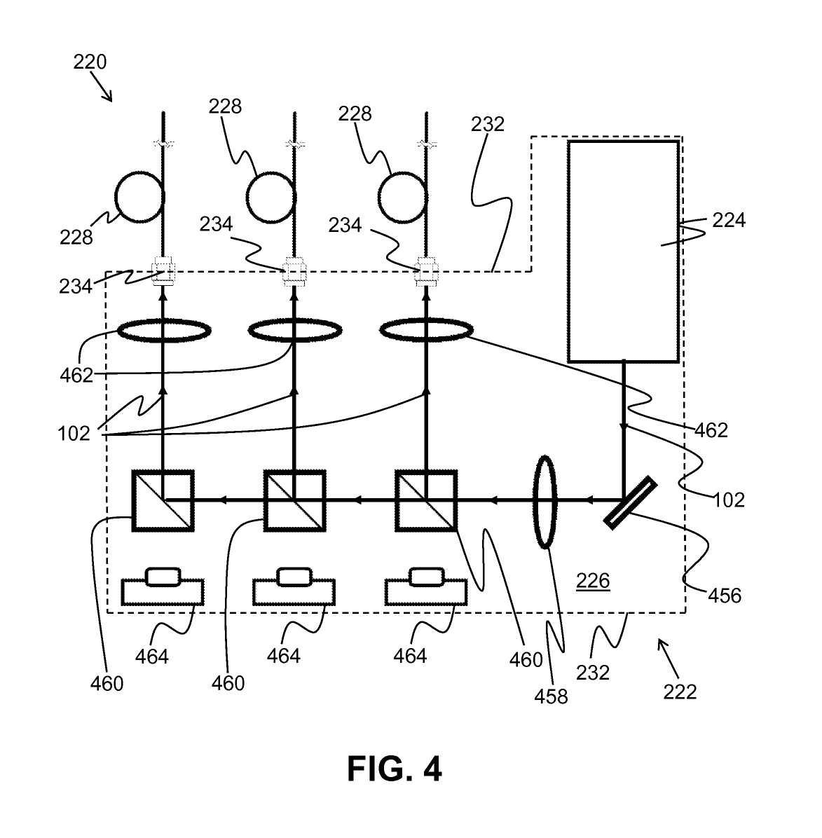

With reference to FIG. 4, an example laser system 222 and optical coupling system 226 for an example LBI system with fiber beam delivery 220 is illustrated. System 220 may include one or more fibers 228 for delivering laser pulse 102 to an inspection head (not shown). In one embodiment, laser pulse 102 produced by laser 222 may be directed by one or more mirrors 456, through one or more optical components, for example a first lens 458, to one or more beam splitters 460. Beam splitters 460 may divide pulsed laser output 102 produced by laser 224 into multiple pulsed beams 102 such that each beam 102 may be coupled into, and delivered by separate optical fibers 228. For example, beams 102 with less than about 5 J of energy with a temporal pulse greater than about 100 ns may be coupled to each fiber 228. While the optical coupling system 226 as illustrated in FIG. 4 may illustrate an example arrangement with 3 beam splitters 460 to split a pulsed laser output 102 produced by laser 224 into 3 pulsed laser beams 102 to couple into 3 optical fibers 228, similar arrangements may be employed to couple a pulsed laser beam 102 produced by laser 224 into more or less fibers 228. Split laser beams 102 may be focused into optical fibers 228 by one or more second lenses 462. Optical fibers 228 in LBI system 220 with fiber beam delivery may be connected to optical coupling system 226, and laser system 222 as whole, by one or more optical connectors 234. Similarly, optical connector 234 may operatively connect fiber 228 to an inspection head (not shown). One or more alignment diode lasers 464 may be used to ensure proper alignment of optical coupling system 226 components such as beam splitter 460 and second lens 462 to ensure proper injection of pulsed laser beam 102 into fiber 228. Laser system 222 may include chassis/housing/cabinet 232 to contain laser 224 and various components of optical coupling system 226. In one embodiment, fiber 228 may attach to optical connector 234 mounted on housing 232.

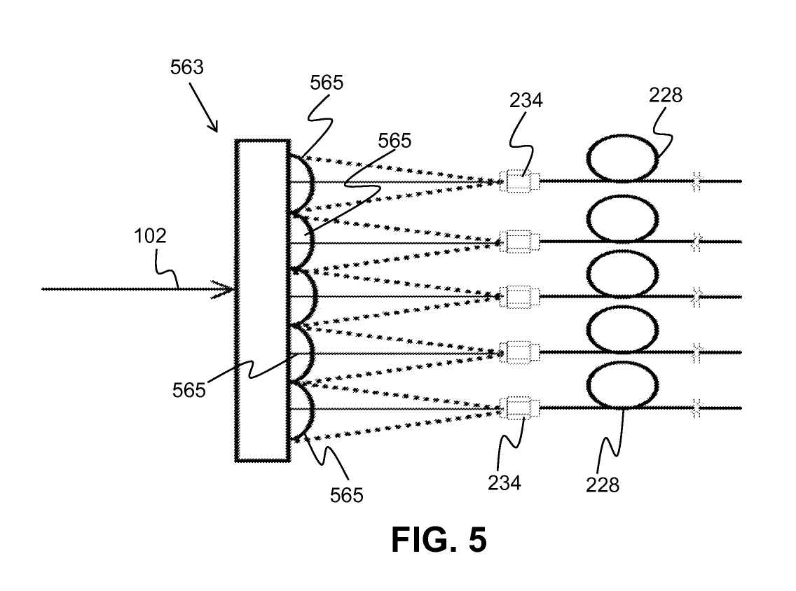

With reference to FIG. 5, an example lenslet array 563 is illustrated. Lenslet array 563 may also be called a micro-lens array 563. Lenslet array 563 may comprise a plurality lenslets 565—that is, micro-lenses 565. Micro-lenses 565 on lenslet array 563 may be operable to focus a single pulsed laser output 102 into a plurality of optical connectors 234, and further into a core of one or more optical fibers 228. In one embodiment, each micro-lens 565 may comprise a same focal length as each other micro-lens 565. In another embodiment, a diffractive optical element (DOE) or diffractive optic design, collectively “diffractive optic,” (not shown), may be used in addition to, or in place of, lenslet array 563 to couple a single pulsed laser output 102 into a plurality of optical connectors 234, and further into a core of one or more optical fibers 228. A diffractive optic may be used to couple single pulsed laser output 102 into one or more optical fibers. Each of lens 462, lenslet array 563, and diffractive optic (not shown), may be operable to focus laser pulse 102 into at least one of: a tapered input section on optical fiber 228 (as shown in FIGS. 8A and 8B), and directly to a face on a core of the optical fiber 228.

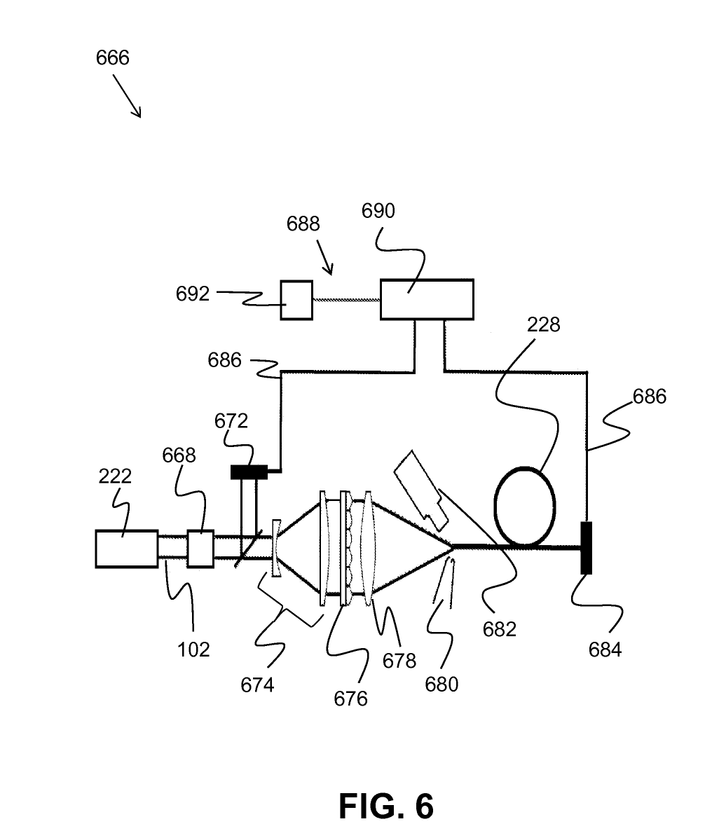

With reference to FIG. 6, an example beam launch scheme 666 of LBI system with fiber beam delivery 220 is illustrated. Beam launch scheme 666 may be used as a test setup to monitor a coupling of laser pulse 102 from laser 224 into optical fiber 228. In one embodiment, beam launch scheme 666 may be used to measure an energy of laser pulse 102 from laser 224 prior to being coupled into fiber 228, and beam launch scheme 666 may be used to measure an energy of laser pulse 102 from laser 224 after being coupled into optical fiber 228. Attenuator 668 may be used reduce an initial energy of laser pulse 102 from laser 222 prior to being coupled into fiber 228. Beam splitter 670 may be used to split laser pulse 102 between a first pyrometer 672 and a telescope 674. First pyrometer 672 may be employed to take an energy measurement of laser pulse 102. Telescope 674, also known as a beam expander may be used to increase a beam diameter of laser pulse 102. Beam homogenizer 676 may be used to smooth any irregularities in laser pulse 102, and to create a more uniform pulsed laser output 102 such that laser pulse 102 comprises a uniform power distribution. Second lens 678 may be used to focus laser pulse 102 into optical fiber 228. Nozzle 680 may be used to provide a purge gas at a face of optical fiber 228. A purge gas from nozzle 680 may be used to keep a face of optical fiber 228 free of contamination, and may be used to minimize an occurrence of burning/ionization of laser pulse 102 upon entry into a face of optical fiber 228. Camera/microscope 682 may be used to monitor a face of optical fiber 228 to detect any burning/ionization of laser pulse 102 and a face of optical fiber 228. A second pyrometer 684 may be used to measure an energy of laser pulse 102 once coupled into optical fiber 228. Measurement system 688 may be operatively connected to first pyrometer 672 and second pyrometer 684 by wired connection 686. Measurement system 688 may comprise a digital signal processor 690 and a processing device 692 that may measure an energy of pulsed laser output 102 prior to being coupled into optical fiber 228, and may measure an energy of pulsed laser output 102 once pulsed laser output 102 has been coupled into optical fiber 228.

Safe operational ranges for various temporal pulse widths of laser pulse 102 are shown in Table 1.

TABLE 1
Energy handling capability of fiber at operational peak irradiance of 1 GW/cm²

| Fiber | Laser | Energy | Fluence | Irradiance | | | |
|---|---|---|---|---|---|---|---|
| Core | Pulse | Damage | Damage | Damage | Number | | |
| Diameter | Width | Threshold | Threshold | Threshold | of | Face | |
| (mm) | (ns) | (J) | (J/cm²) | (GW/cm²) | Pulses | Prep. | Ref. |
| 0.365 | 15 | 0.055 | 53 | 3.5 | | Polished | 2 |
| 0.365 | 15 | 0.065 | 62 | 4.1 | | Polished + | |
| | | | | | | CO2 | 2 |
| | | | | | | Laser | |
| 0.600 | 15 | 0.125 | 44 | 2.9 | | | 3 |
| 0.200 | 25 | 0.029 | 92 | 3.7 | | Polished | 4 |
| 0.400 | 16 | 0.100 | 80 | 5.0 | 20 | Polished | 5 |
| 0.940 | 15 | 0.130 | 19 | 1.2 | 900 | Cleaved | 6 |
| 1.500 | 15 | >0.200 | >11 | >0.8 | >10⁶ | Cleaved | 7 |
| 1.500 | 15 | 0.800 | 45 | 3.0 | | | 8 |

A single fiber 228 may handle up to about 5 J of energy for about a 300 ns temporal pulse. Thus, five fibers 228 may have a capability of delivering up to about 25 J to inspection head 230.

One key design parameter of, for example, LBI system with fiber beam delivery 220 may be a number of optical fibers 228 required to deliver a specified amount of pulsed laser energy 102 for an LBI application. This design parameter may need to balance minimizing a number of optical fibers 228 against maximizing a probability of long-term survival of any single optical fiber 228. In one embodiment, a definite number of optical fibers 228 may be selected based on a damage threshold of optical fiber 228. An energy level of laser pulse 102 inside optical fiber 228 may determine a lifetime of optical fiber 228. Design considerations of LBI system with fiber beam delivery 220 may include a determination of an operational level for each optical fiber 228 as a percentage of an optical fiber's 228 damage threshold. For example, a design may be selected such that optical fibers 228 propagate laser pulses 102 at energy levels less than 10% of a damage threshold for optical fibers 228. This design consideration may maximize a lifetime (i.e. operational life) of optical fiber 228. In another example, a design consideration that may choose to propagate laser pulse 102 through optical fiber 228 at an energy level between 90% and 100% of a damage threshold for optical fiber 228 may cause a significantly shorter operational life for optical fiber 228. A number of optical fibers 228 that may be used to realize LBI system with fiber beam delivery 220 may depend on a “safety factor” chosen by a designer of a LBI system with fiber beam delivery 220. Geometry of optical fiber 228 to best match a shape of pulsed laser 102 to physical constraints of optical fiber 228, may be another consideration in selecting a number of optical fibers 228 that may be used in designing an LBI system with fiber beam delivery 220.

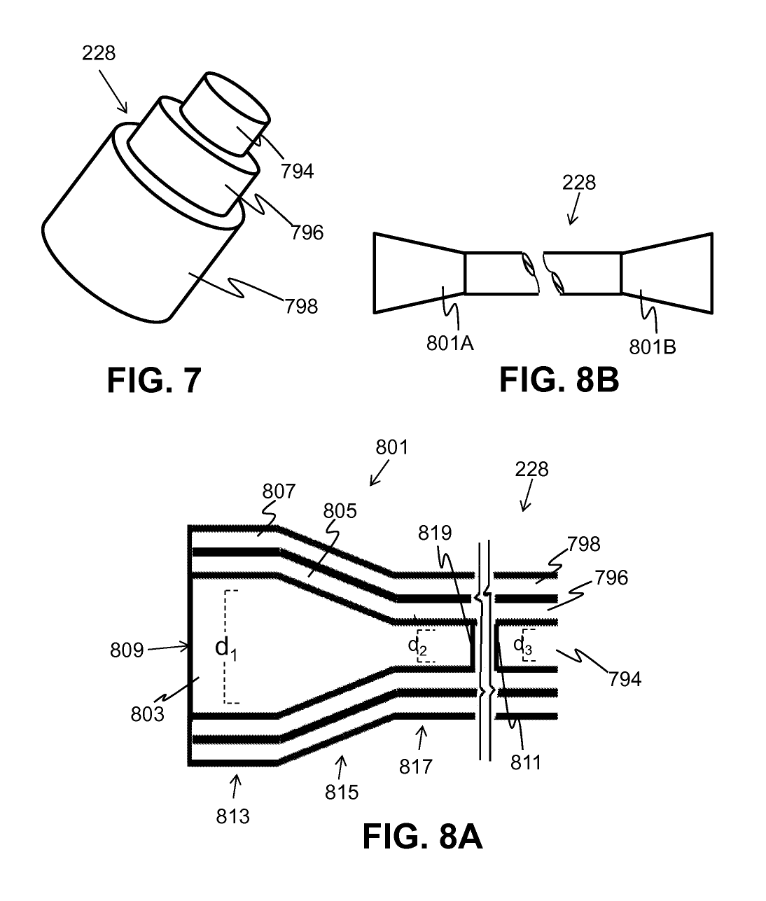

Referring to FIG. 7, a perspective view of an example step index fiber 228 is illustrated. Step index fiber 228 may be used, for example, as one or more optical fibers 228 in example LBI systems with fiber beam delivery 220. Optical fiber 228 may comprise a core 794, a cladding 796, and an outer coating 798. Core 794 may be a cylinder of glass or plastic running a length of optical fiber 228. In one embodiment, core 794 may be of a high-purity fused silica (SiO₂) glass material. A material of core 794 may be doped with different concentrations of elements, and compounds containing elements such as, but not limited to: titanium (Ti), germanium (Ge), boron (B), fluorine (F), and aluminum (Al) to change a refractive index of core 794. In one embodiment, core 794 may be of a material with a uniform refractive index. Core 794 may be surrounded by cladding 796. Cladding 796 may have a lower refractive index than core 794, such that a core-cladding interface (i.e. where core 794 meets cladding 796) may have a lower refractive index than core 794. Cladding 796 may be of a glass or plastic material and may be toroidal in shape. Cladding 796 may completely surround core 794 and may run a length of optical fiber 228. In one embodiment, cladding 796 may be a TEQS® hard cladding (Thorlabs Inc., Newton, N.J.). Coating 798 may cover a surface of cladding 796 not in contact with core 794. In one embodiment, coating 798 may comprise one or more layers of coatings of different materials (not shown). Coating 798 may protect optical fiber 228 from damage but may not contribute to optical waveguide properties of optical fiber 228 like core 794 and cladding 796. Coating 798 may be comprised of a plastic or other polymeric material. In one embodiment, coating 798 may be comprised of Ethylene tetrafluoroethylene (ETFE) or other fluorine based plastic. In one embodiment, optical fiber 228 may be a hollow-core fiber 228, and core 794 may be, for example hollow with air or another gas in place of core 794. In one embodiment, optical fiber 228 may be a step-index profile multimode optical fiber 228 and may be operable to transmit and maintain a flat top-shaped laser pulse 102 produced by a laser system 222.

A key parameter in evaluating pulsed laser transmission may be an irradiance damage threshold of core 794. Pure silica may have a highest intrinsic, single-pulse, bulk damage threshold of an optical fiber material which may be greater than about 400 GW/cm² with about an 8 ns pulse width. As used herein “face” may refer to an input/output surface of optical fiber 228, for example, where laser pulse 102 enters or exits optical fiber 228. A practical damage threshold for an optical fiber 228 with a core 794 of silica may be determined by a minimum laser irradiance that may damage an input surface face of optical fiber 228 which may be typically less than 12 GW/cm² (peak power). Factors that may affect a pulse-energy threshold of optical fiber 228 may include: silica type and quality; entrance and exit face preparation of optical fiber 228; a spatial profile of laser pulse 102 (i.e. intensity spikes) at an entrance face of optical fiber 228; beam alignment of laser pulse 102 to an axis of optical fiber 228; beam launch geometry; an entrance diameter of optical fiber 228; and a beam launch environment. In testing, for example, where laser pulse 102 was coupled to an input face of core 794 alone, damage first occurred on an input face of core 794. Damage is progressive such that multiple pulsing (i.e. delivery of multiple laser pulses 102 through optical fiber 228) may eventually causes microscopic damage sites to grow into catastrophic damage conditions, and thereby may define a lower damage threshold for each subsequent laser pulse 102. Irradiance damage threshold may depend considerably on beam launching conditions, an entrance diameter of optical fiber 228, and a face preparation of optical fiber 228.

Generally, peak irradiance levels may be classified with the following design guidelines: 1) from about 1 GW/cm² to about 3 GW/cm² (peak power) there may be cause to utilize high-power design implementation; 2) from about 3 GW/cm² to about 9 GW/cm² there may be cause: for extreme care to ensure a stable laser output and laser beam homogeneity of laser pulse 102, to provide proper injection of laser pulse 102 into optical fiber 228, and to ensure a correct manufacture of a high-power optical fiber 228; and 3) above about 9 GW/cm² fiber delivery design may be very difficult to implement without employing tapered fibers—that may be, an optical fiber 228 comprising a tapered I/O section.

Referring again to Table 1, data collected from prior testing, specifically data in the second to last row, shows a pulse energy of laser pulse 102 deliberately kept well below a damage threshold condition to enhance long term survivability of optical fiber 228 in daily use at 10 Hz pulse repetition rates.

In one embodiment, optical fiber 228 may comprise: a silica core 794, core 794 comprising diameter of around 1.5 mm, a step index of refraction between core 794 and cladding 796 for maintaining a transmission of laser pulse 102; a multimode fiber to maintain a flat top-shaped laser pulse 102, and a temperature operation range from around −65° C. to around 135° C. In this embodiment, optical fiber 228 with similar parameters may be available from Thorlabs, Inc. (Newton, N.J.). Again, 1 GW/cm² peak irradiance may be a conservative design starting point for an LBI system with fiber beam delivery 220. Based on a 1 GW/cm² peak irradiance level, laser pulse energies may be delivered for pulse widths as illustrated in Table 2. In another embodiment, core 794 of optical fiber 228 may comprise a diameter between about 0.25 mm to about 3.0 mm.

TABLE 2
Estimated safe pulse energy levels per pulse duration

| | Operational | Laser | Operational |
|---|---|---|---|
| Fiber Core | Peak | Pulse | Pulse |
| Diameter | Irradiance | Width | Energy |
| (mm) | (GW/cm²) | (ns) | (J) |
| 1.500 | 1 | 20 | 0.4 |
| 1.500 | 1 | 100 | 1.8 |
| 1.500 | 1 | 200 | 3.5 |
| 1.500 | 1 | 300 | 5.3 |

Optical Fibers 228 may be carefully selected, prepared, and conditioned for long life. A required length of optical fiber 228 may be cut and specially prepared for use in a high-pulse power application. In one embodiment, a special, modified SMA-905 optical connector 234 may be used to hold, and maintain a position of at least one of: an input face of a tapered I/O section of optical fiber 228 comprising a tapered I/O section, and an input face of optical fiber 228.

Referring to FIGS. 8A and 8B, examples of a tapered input/output (“I/O”) section 801 attached to optical fiber 228 are illustrated. Though illustrated as a broken connection with break line in FIG. 8A to illustrate a distinction between tapered I/O section 801 and optical fiber 228, tapered I/O section 801 and optical fiber 228 may be spliced together as one assembly. In one embodiment, optical fiber 228 may comprise at least one tapered I/O section 801. Tapered I/O section 801 may be used as both an input and as an output to optical fiber 228. Optical fiber 228 may comprise a tapered I/O section 801 operating as an input 801A, and a tapered I/O section 801 operating as an output 801B. In one embodiment, optical fiber 228 comprises only tapered input 801A that may be operable to couple a laser pulse 102 into an optical fiber 228. In another embodiment, optical fiber 228 may comprise only a tapered output 801B that may be operable to reduce an energy density at a fiber/air interface when laser pulse 102 may be output from optical fiber 228. Tapered input/output section 801 may comprise a tapered core 803, a tapered cladding 805, and a tapered outer coating 807. In one embodiment, tapered core 803 may be of a silica (SiO₂) material, and share properties similar to core 794 as described above. Tapered core 803 may comprise a first entry/exit face, known also as a “first face” 809. First face 809 may be used as an entry point for coupling and injecting laser pulse 102 into tapered I/O section 801, and further into core 794 of optical fiber 228. Tapered I/O section 801 may further comprise a second entry/exit face, known also as a “second face” 819 that may correspond to an entry/exit face, known also as “optical fiber face” 811, on core 794 of optical fiber 228. A junction of second face 819 and optical fiber face 811 may be a threshold where laser pulse energy 102 injected into tapered I/O section 801 may be transferred from tapered I/O section 801 and injected into optical fiber 228.

A significant limiting factor in transmitting high pulsed laser energy 102 through optical fiber 228 for LBI may be how laser pulse 102 is coupled into optical fiber 228. Considering optical fiber 228 alone without tapered I/O section 801, optical fiber face 811 of core 694 on optical fiber 228 may be less than about 1 mm in diameter d₂, which may limit an amount of energy of laser pulse 102 that may be coupled into optical fiber 228 without damaging optical fiber face 811. Core 794 may have a damage threshold much greater than optical fiber face 811. A damage threshold for optical fiber face 811 may be less than about 20 J/cm², while a damage threshold for core 794 may be greater than about 3,200 J/cm² for laser pulse 102 with a pulse width of about 8 ns. Given such a low damage threshold at optical fiber face 811, optical fiber face 811 may be a weak link of optical fiber 228. Damage to optical fiber face 811 may be lessened by using an optical fiber 228 comprising a tapered section I/O section 801 to couple and inject laser pulse 102 into optical fiber 228.

Laser fluence, also known as radiant exposure or radiant fluence, is a beam energy of laser pulse 102 received by a surface per unit area, for example, as may be received by first face 809 and optical fiber face 811. Increasing a first a diameter d₁ of core 803 on face portion 813 may increase an overall area of first face 809 such that laser fluence at first face 809 may be significantly reduced, which may reduce a probability of overall damage to optical fiber 228, and may allow laser pulse 102 of a higher energy to be coupled and injected into optical fiber 228. Face portion 813 may be defined as portions of tapered I/O section 801 with tapered core 803 comprising a first diameter d₁. Taper portion 815 may decrease a diameter of tapered core 803 from a first diameter d₁ to a second diameter d₂. Taper portion 815 may comprise tapered core 803 of decreasing diameter relative to diameter d₁ of tapered core 803 in face portion 813. Stem portion 817 may comprise tapered core 803 of a second diameter d₂ and be defined as portions of tapered I/O section 801 comprising tapered core 803 of second diameter d₂. In one embodiment, tapered I/O section 801 may resemble a conical, or frustoconical shape, for example, like that of a common funnel, with face portion 813 corresponding to the mouth of the funnel, tapered portion 815 corresponding to the conical or frustoconical portion of a funnel, and stem portion 817 corresponding to the stem of the funnel. Stem portion 817 with tapered core 803 of a second diameter d₂ may be equal in measurement to a diameter d₃ of core 794 on optical fiber 228, such that second face 819 and optical fiber face 811 may be concentric, and may comprise a diameter, a circumference, and an area of equal measurements. In one embodiment, a diameter, a circumference, and an area of stem portion 817 may be equal in measurement to a diameter, a circumference, and an area of optical fiber 228 such that measurements of tapered core 803, tapered cladding 805, and tapered outer coating 809 on stem portion 817 may concentrically correspond to, and may align with coating 794, cladding 796, and outer coating 798 that may comprise the same measurements as of tapered core 803, tapered cladding 805, and tapered outer coating 809, respectively, on optical fiber 228.

Using tapered I/O section 801, higher energy laser pulses 102 may be transmitted over greater distances via optical fiber 228 to a bonded article undergoing laser bond inspection. In one embodiment, optical fiber 228 may comprise a length of 50 feet or greater. By using tapered I/O section 801 with optical fiber 228, a laser pulse 102, for example, with energy up to about 5 Joules for about a 300 ns pulse beam may be transmitted through optical fiber 228.

Utilizing tapered I/O section 801 with optical fiber 228 may cause a diameter d₃ of core 794 in optical fiber 228 to be reduced to a diameter equal to, or less than about 1 mm. A reduction in diameter d₃ of core 794 in optical fiber 228 may enable a greater flexibility of motion in optical fiber 228, and consequently an umbilical assembly which may ease maneuvering and positioning of an inspection head during laser bond inspection.

Tapered I/O section 801 may be connected to optical fiber 228 by a splice or connector (not shown) between second face 819 and optical fiber face 811. A splice may be a permanent joining of tapered I/O section 801 to optical fiber 228, while a connector may be a temporary joining of tapered I/O section 801 to optical fiber 228. A splice between tapered I/O section 801 and optical fiber 228 may comprise at least one of: a fusion splice, an adhesive, an index matching gel, and a mechanical splice. In one embodiment, a splice may be selected to minimize loss of, for example, a laser pulse energy lost in the transition of laser pulse 102 from tapered I/O section 801 to fiber 226 at a threshold between second face 819 and optical fiber face 811. Only light from laser pulse 102 coupled into core 794 in optical fiber 228 may further propagate and may be transmitted through optical fiber 228. Light from laser pulse 102 that may not be coupled into core 794 on optical fiber 228 may be lost, and may not be transmitted through optical fiber 228. Splice loss may be caused by a number of factors, and may minimized when tapered core 803 of tapered I/O section 801 may be identical in size and measurement, and perfectly aligned to core 794 of optical fiber 228, for example, when second face 819 may match in size and measurement, and concentrically align to optical fiber face 811. Second face 819 and optical fiber face 811 may be caused to be cleaned, polished, and may be further prepared prior to splicing tapered I/O section 801 to optical fiber 228 to minimize loss caused by, but not limited to, any of: end gaps, end angles, and axial runout between second face 819 and optical fiber face 811, concentricity and coaxiality mismatch of second face 819 and optical fiber face 811, numerical aperture and core diameter mismatch between second face 819 and optical fiber face 811, a finish or dirt on at least one of: second face 819, and optical fiber face 811, and back reflection or return loss between second face 819 and optical fiber face 811. A fusion splice may cause less loss and less reflectance, and may be stronger and more reliable than other splices. A fusion splice may “weld” second face 819 of tapered I/O section 801 to optical fiber face 811 on optical fiber 228 using heat. A heat source for a fusion splice may be an electric arc, a laser, a gas flame, or a current-carrying tungsten filament. A mechanical splice in addition to an index matching gel or adhesive applied between second face 819 and optical fiber face 811 may be used to mechanically splice I/O section 801 to optical fiber 228. Mechanical splices may comprise, but may not be limited to: glass tubes, and v-shaped metal clamps. Any of tapered I/O section 801, second face 819, optical fiber 228, and optical fiber face 811 may be caused to be any of: stripped, cleaned, cleaved, and aligned prior to splicing. In one embodiment, a splice between second face 819 on tapered I/O section 801 and optical fiber face 811 on optical fiber 228 may allow for a laser pulse 102 of higher energy to be transferred from tapered I/O section 801 through optical fiber 228.

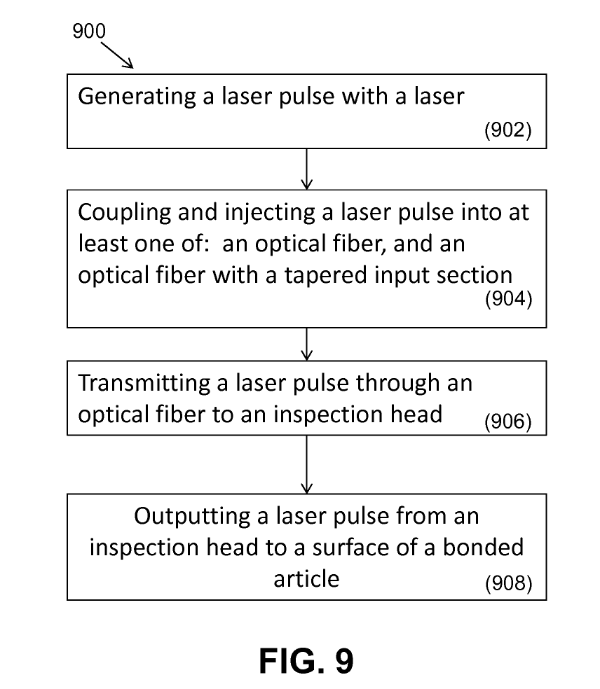

Referring to FIG. 9, a flow chart of an example method 900 for transmitting and propagating a laser pulse via an optical fiber for use in laser bond inspection is illustrated. In one embodiment, method 900 may comprise: generating a laser pulse with a laser (902); coupling and injecting a laser pulse into at least one of: an optical fiber, and tapered input section of an optical fiber (904); transmitting a laser pulse through an optical fiber to an inspection head (906); and outputting a laser pulse from an inspection head to a surface of a bonded article (908).

Unless specifically stated to the contrary, the numerical parameters set forth in the specification, including the attached claims, are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example embodiments, and while the example embodiments have been described and illustrated in considerable detail, it is not the intention of the applicants to restrict, or in any way limit, the scope of the appended claims to such detail. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and exemplary embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

As used in the specification and the claims, the singular forms “a,” “an,” and “the” include the plural. To the extent that the term “includes” or “including” is employed in the detailed description or the claims, it is intended to be inclusive in a manner co-extensive with the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

What is claimed:

1. A system for fiber delivery of a laser pulse for laser bond inspection, the system comprising:
a laser operable to produce the laser pulse;
an optical fiber; and
an inspection head.

2. The system of claim 1, wherein the laser pulse comprises an energy from about 1 J to about 50 J with a temporal pulse width between about 50 ns and about 300 ns.

3. The system of claim 1 further comprising an optical connector, the optical connector operable to connect the optical fiber to at least one of: an optical table, an optical rail, a chassis housing the laser and other optical components, and the inspection head, wherein the optical connector is further operable to maintain a position of at least one of: a face on a tapered input/output section, and a face on a core of the optical fiber, relative to the at least one of: the optical table, the optical rail, the chassis, and the inspection head.

4. The system of claim 1 further comprising a mirror, the mirror operable to direct the laser pulse to other optical components in the system.

5. The system of claim 1 further comprising a beam splitter, the beam splitter operable to split the laser pulse.

6. The system of claim 1 further comprising at least one of:
a lens;
a lenslet array; and
a diffractive optic,
wherein the at least one of: the lens, the lenslet array, and the diffractive optic, is operable to focus the laser pulse into at least one of: a tapered input section on the optical fiber, and a face on a core of the optical fiber.

7. The system of claim 1 further comprising an alignment laser, the alignment laser operable to align optical components in the system.

8. The system of claim 1, wherein the optical fiber further comprises a core, a cladding, and an outer coating.

9. The system of claim 1, wherein the optical fiber is a step-index profile multimode optical fiber, the step-index profile multimode optical fiber comprising: a core with a uniform refractive index, a cladding with a core-cladding interface with a lower refractive index than the refractive index of the core, and an outer coating, wherein the step-index profile multimode optical fiber is operable to maintain a flat top beam.

10. The system of claim 1, wherein a core of the optical fiber is comprised of a high-purity fused silica glass (SiO₂) material.

11. The system of claim 1, wherein a core of the optical fiber comprises a diameter between about 0.25 mm to 3.0 mm.

12. The system of claim 1 further comprising a flexible umbilical assembly, the flexible umbilical assembly comprising a flexible and protective material and operable to:
enshroud the optical fiber and a cable used to operate the inspection head, protect the optical fiber and the cable from damage, and flex to provide repositioning of the optical fiber and the cable to provide repositioning of the inspection head relative to a bonded article.

13. The system of claim 1, wherein the optical fiber is comprised of at least one of: a tapered input section, and a tapered output section.

14. The system of claim 13, wherein the at least one of: the tapered input section, and the tapered output section comprises:
a core;
a cladding;
an outer coating;
a face portion for at least one of: inputting, and outputting, the laser pulse, wherein the core in the face portion is of a first diameter;
a tapered portion comprising a decreasing core diameter relative to the face portion and operable to decrease the first diameter to a second diameter; and
a stem portion, wherein the core in the stem portion is of the second diameter, and wherein the core of the second diameter corresponds to a core diameter of the optical fiber.

15. The system of claim 13, wherein the at least one of: the tapered input section, and the tapered output section, comprises a splice to create a permanent junction between the at least one of: the tapered input section, and the tapered output section, and the optical fiber, wherein the splice comprises at least one of: a fusion splice, an adhesive, an index matching gel, and a mechanical splice.

16. The system of claim 1, wherein the optical fiber comprises a length of 50 feet or greater.

17. A system for fiber delivery of a laser beam used for laser bond inspection, the system comprising:
a laser system, the laser system comprising:
a laser, the laser configured to produce a laser pulse in an energy range from 1 J to 50 J with a temporal pulse width between 50 ns and 300 ns in a low-high-low pulse energy sequence to produce stress waves through a bond of a bonded article;
an optical coupling system for coupling the laser pulse to an optical fiber, the optical coupling system comprising:
a mirror operable to direct the laser pulse to another optical component;
at least one of: a lens, a lenslet array, and a diffractive optic, the at least one of the lens, the lenslet array, and the diffractive optic, operable to focus the laser pulse into a core of at least one of: the optical fiber, and a tapered input section of the optical fiber; and
a first optical connector operable to connect the laser system with the optical fiber;
the optical fiber operatively connected to the laser system, wherein the optical fiber comprises a core, a cladding, and an outer coating;
a cable to operate the inspection head, wherein the cable comprises at least one of:
a power cable, a signal cable, and a hose;
an inspection head, the inspection head operatively connected to the optical fiber and operable to output the laser pulse to the bonded article, the inspection head further comprising:
a second optical connector operable to connect the inspection head with the optical fiber;
an overlay output operable to generate at least one of: a transparent overlay and an opaque overlay;
a laser output operable to output the laser pulse;
a connection device operable to attach the inspection head to the bonded article;
an evacuation device operable to remove effluent and backscatter produced during the LBI process; and
a surface motion detector, wherein the surface motion detector is operable to detect and measure surface motion on the bonded article.

18. The system of claim 17, wherein the tapered input section of the optical fiber comprises:
the core;
a cladding;
an outer coating;
an entry face portion for receiving a laser pulse, wherein the core in the entry face portion is of a first diameter;
a tapered section comprising a decreasing core diameter relative to the entry face portion and operable to decrease the first diameter to a second diameter; and
a stem portion comprising a core of the second diameter, wherein the second diameter corresponds to a core diameter of the optical fiber.

19. The system of claim 17, further comprising an umbilical assembly, the umbilical assembly comprising a flexible and protective material and operable to protect and enshroud at least one of: the optical fiber, and the cable.

20. A method for fiber optic delivery of a laser pulse to a bonded article under laser bond inspection, the method comprising:
generating a laser pulse with a laser;
coupling and injecting the laser pulse into at least one of: an optical fiber, and a tapered input section of an optical fiber;
transmitting the laser pulse through the optical fiber to an inspection head; and
outputting the laser pulse from the inspection head to a surface of a bonded article.
